(19) United States
(12) Patent Application Publication
(10) Pub. No.: US 2022/0379958 A1
(43) Pub. Date: Dec. 1, 2022

(54) SYSTEMS AND METHODS FOR PROVIDING TOWING STEERING ASSISTANCE DURING IN-FLIGHT CHARGING OF ELECTRIFIED VEHICLES

(71) Applicant: FORD GLOBAL TECHNOLOGIES, LLC, Dearborn, MI (US)

(72) Inventors: Stuart C. SALTER, White Lake, MI (US); Kenneth Patrick MCHUGH, Canton, MI (US); Peter PHUNG, Windsor (CA); David Brian GLICKMAN, Southfield, MI (US); Paul Kenneth DELLOCK, Northville, MI (US)

(21) Appl. No.: 17/331,143

(22) Filed: May 26, 2021

(51) Int. Cl. B62D 12/00; B60D 1/62; B62D 6/00; B62D 5/04; B60L 53/18

(52) U.S. Cl. CPC B62D 12/00; B60D 1/62; B62D 6/00; B62D 5/04; B60L 53/18

(57) ABSTRACT

Systems and methods for coordinating and providing steering assistance between towing vehicles and towed vehicles during towing events. The towing steering assistance may be provided by the towed vehicle in the form of assistive steering maneuvers to assist the towing vehicle with turning during the towing event. The assistive steering maneuvers may be provided to account for turning maneuvers, steering compensation, and stability events of the coupled vehicles during the towing events, for example.

### TECHNICAL FIELD

This disclosure is directed to vehicle systems and methods for coordinating and providing steering assistance during vehicle-to-vehicle towing events.

### BACKGROUND

Electrified vehicles differ from conventional motor vehicles because they are selectively driven by one or more traction battery pack powered electric machines. The electric machines can propel the electrified vehicles instead of, or in combination with, an internal combustion engine. Plug-in type electrified vehicles include one or more charging interfaces for charging the traction battery pack. Plug-in type electrified vehicles are typically charged while parked at a charging station or some other utility power source.

### SUMMARY

A vehicle-to-vehicle in-flight energy transfer system, according to an exemplary aspect of the present disclosure includes, among other things, a towing vehicle, a towed vehicle, and a control module programmed to request an assistive steering maneuver from the towed vehicle during a towing event between the towing vehicle and the towed vehicle.

In a further non-limiting embodiment of the foregoing system, the towing vehicle is a smaller vehicle than the towed vehicle.

In a further non-limiting embodiment of either of the foregoing systems, the towed vehicle is coupled to the towing vehicle by a towing device during the towing event in which the assistive steering maneuver is requested.

In a further non-limiting embodiment of any of the foregoing systems, the towing event is an in-flight bidirectional charging towing event.

In a further non-limiting embodiment of any of the foregoing systems, the control module is a component of the towing vehicle.

In a further non-limiting embodiment of any of the foregoing systems, the control module is programmed to transmit a steering assistance request signal to the towed vehicle when a steering wheel of the towing vehicle is turned.

In a further non-limiting embodiment of any of the foregoing systems, the steering assistance request signal includes steering-related data associated with the towing vehicle.

In a further non-limiting embodiment of any of the foregoing systems, the steering related data includes at least a yaw rate, a lateral acceleration, a wheel speed, and a steering wheel angle of the towing vehicle.

In a further non-limiting embodiment of any of the foregoing systems, the control module is programmed to automatically communicate the steering assistance request signal in response to receiving an input signal from a steering system of the towing vehicle. The input signal indicates that the steering wheel of the towing vehicle has been turned.

In a further non-limiting embodiment of any of the foregoing systems, the control module is programmed to command that manual steering controls of the towed vehicle be disabled during the towing event.

In a further non-limiting embodiment of any of the foregoing systems, the assistive steering maneuver is configured to mimic a turn rate of the towing vehicle.

In a further non-limiting embodiment of any of the foregoing systems, the assistive steering maneuver is configured to compensate for an understeering or an oversteering condition of the towing vehicle.

In a further non-limiting embodiment of any of the foregoing systems, the assistive steering maneuver is configured to artificially create an oversteer condition of the towing vehicle.

An electrified vehicle according to another exemplary aspect of the present disclosure includes, among other things, a drive wheel, a steering system for electronically steering the drive wheel, and a control module programmed to control the steering system for steering the drive wheel in response to receiving a steering assistance request signal during a towing event.

In a further non-limiting embodiment of the foregoing electrified vehicle, the steering assistance request signal is received from a second electrified vehicle.

In a further non-limiting embodiment of either of the foregoing electrified vehicles, a telecommunications module is configured for establishing bidirectional communications between the electrified vehicle and the second electrified vehicle.

In a further non-limiting embodiment of any of the foregoing electrified vehicles, the control module is a component of the electrified vehicle being towed during the towing event.

In a further non-limiting embodiment of any of the foregoing electrified vehicles, the steering assistance request signal includes steering-related information received from a second electrified vehicle that is coupled to the electrified vehicle during the towing event.

In a further non-limiting embodiment of any of the foregoing electrified vehicles, the control module is programmed to calculate a required steering compensation necessary for achieving a steering target indicated by the steering assistance request signal and communicate a steering command signal to the steering system for commanding the steering system to execute the required steering compensation.

A method according to another exemplary aspect of the present disclosure includes, among other things, during a towing event in which a towing vehicle is towing a towed vehicle, controlling the towed vehicle to provide an assistive steering maneuver for providing a coupled maneuvering of the towed vehicle and the towing vehicle.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a first in-flight configuration of a vehicle-to-vehicle energy transfer system during a towing event.

FIG. 2 schematically illustrates a second in-flight configuration of the vehicle-to-vehicle energy transfer system of FIG. 1.

FIG. 3 schematically illustrates another towing event of a vehicle-to-vehicle energy transfer system.

FIG. 4 schematically illustrates exemplary steering assistance aspects of a vehicle-to-vehicle energy transfer system.

FIG. 5 schematically illustrates a first exemplary steering use case that can be achieved via the vehicle-to-vehicle energy transfer system of FIG. 4.

FIG. 6 schematically illustrates a second exemplary steering use case that can be achieved via the vehicle-to-vehicle energy transfer system of FIG. 4.

FIG. 7 schematically illustrates a third exemplary steering use case that can be achieved via the vehicle-to-vehicle energy transfer system of FIG. 4.

FIG. 8 schematically illustrates a fourth exemplary steering use case that can be achieved via the vehicle-to-vehicle energy transfer system of FIG. 4.

FIG. 9 is a flow chart of an exemplary method for providing steering assistance during vehicle towing events.

### DETAILED DESCRIPTION

This disclosure is directed to systems and methods for coordinating and providing steering assistance between towing vehicles and towed vehicles during towing events. The towing steering assistance may be provided by the towed vehicle in the form of assistive steering maneuvers to assist the towing vehicle with turning during the towing event. The assistive steering maneuvers may be provided to account for turning maneuvers, steering compensation, and stability events of the coupled vehicles during the towing events, for example. These and other features of this disclosure are discussed in greater detail in the following paragraphs of this detailed description.

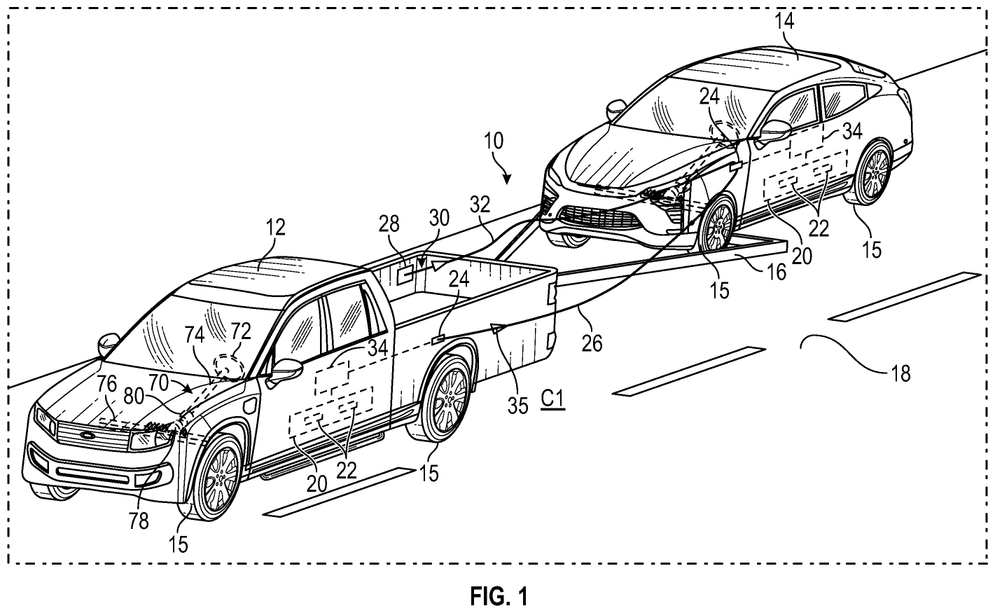

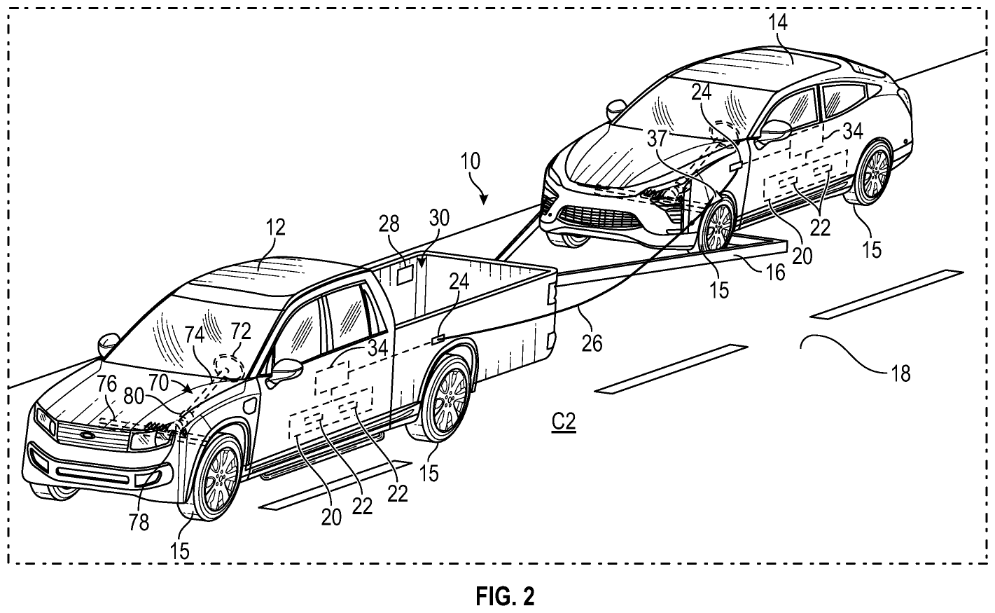

FIGS. 1 and 2 schematically illustrate an exemplary vehicle-to-vehicle (V2V) in-flight energy transfer system 10 (hereinafter “the system 10”) for bidirectionally transferring energy between a towing or leading vehicle 12 and a towed or trailing vehicle 14 during a towing event. In this disclosure, the term “in-flight” means during the coupled movement of the leading vehicle 12 and the trailing vehicle 14. Accordingly, the system 10 enables the bidirectional transfer of energy from the leading vehicle 12 to the trailing vehicle 14 or vice-versa while the leading and trailing vehicles 12, 14 are coupled together and making forward progress toward their desired destinations.

Although a specific component relationship is illustrated in the figures of this disclosure, the illustrations are not intended to limit this disclosure. The placement and orientation of the various components of the depicted vehicles are shown schematically and could vary within the scope of this disclosure. In addition, the various figures accompanying this disclosure are not necessarily drawn to scale, and some features may be exaggerated or minimized to emphasize certain details of a particular component.

The in-flight energy transfer afforded by the system 10 is beneficial to both participating parties. For example, the user/owner of the trailing vehicle 14 may take advantage of the time while being towed by resting, sleeping, eating, working, etc., and the user/owner of the leading vehicle 12 may generate income for performing the towing/charging task (e.g., revenue opportunity).

A towing device 16 may releasably couple the trailing vehicle 14 relative to the leading vehicle 12 to allow the leading vehicle 12 to pull the trailing vehicle 14 along a roadway 18 and thus control driving of the trailing vehicle 14 during a towing event. The towing device 16 could by any type of towing device. Accordingly, the specific configuration of the towing device 16 is not intended to limit this disclosure.

In an embodiment, the leading vehicle 12 and the trailing vehicle 14 are both plug-in type electrified vehicles (e.g., a plug-in hybrid electric vehicle (PHEV) or a battery electric vehicle (BEV)). Each of the leading and trailing vehicles 12, 14 includes a traction battery pack 20. The leading vehicle 12 and the trailing vehicle 14 may each include an electrified powertrain capable of applying a propulsive torque from an electric machine (e.g., an electric motor) for driving drive wheels 15 of the leading and trailing vehicles 12, 14. Therefore, the powertrain of each of the leading vehicle 12 and the trailing vehicle 14 may electrically propel the respective set of drive wheels 15 either with or without the assistance of an internal combustion engine.

Although shown schematically, each traction battery pack 20 may be configured as a high voltage traction battery pack that includes a plurality of battery arrays 22 (i.e., battery assemblies or groupings of battery cells) capable of outputting electrical power to one or more electric machines of each vehicle. Other types of energy storage devices and/or output devices may also be used to electrically power each of the leading vehicle 12 and the trailing vehicle 14.

From time to time, charging the energy storage devices of the traction battery pack 20 of each of the leading vehicle 12 and the trailing vehicle 14 may be required or desirable. Each of the leading and trailing vehicles 12, 14 may therefore be equipped with a charging system that includes a charge port assembly 24. A charge cable 26 (e.g., EVSE) may be connected to the corresponding charge port assemblies 24 of the leading and trailing vehicles 12, 14 in order to transfer charge energy from the traction battery pack 20 of the leading vehicle 12 or the trailing vehicle 14 to the traction battery pack 20 of the other of the leading vehicle 12 or the trailing vehicle 14. The charge cable 26 may be configured to provide any level of charging (e.g., Level 1 AC charging, Level 2 AC charging, DC charging, etc.).

The charging system of the leading vehicle 12 could optionally be equipped with a secondary charge port assembly 28. In an embodiment, the secondary charge port assembly 28 is mounted within a cargo space 30 of the leading vehicle 12 for providing access to a power source at an external location of the leading vehicle 12. A charge cable 32 may be connected to the secondary charge port assembly 28 and the charge port assembly 24 of the trailing vehicle 14 in order to transfer charge energy from the traction battery pack 20 of one of the leading vehicle 12 or the trailing vehicle 14 to the traction battery pack 20 of the other of the leading vehicle 12 or the trailing vehicle 14. The charge cable 32 may be configured to provide Level 1 or Level 2 AC charging, for example. In another embodiment, energy can be transferred between the leading and trailing vehicles 12, 14 using both the charge cable 26 and the charge cable 32. Although not specifically shown, the leading vehicle 12 and/or the trailing vehicle 14 could be equipped with one or more additional charging interfaces.

The respective charging systems of the leading and trailing vehicles 12, 14 may additionally include a bidirectional power transfer system 34 configured for enabling the bidirectional transfer of power between the vehicles 12, 14. The bidirectional power transfer system 34 may be operably connected between the charge port assembly 24 and the traction battery pack 20 of each of the leading vehicle 12 and the trailing vehicle 14. The bidirectional power transfer system 34 may include various equipment, such as a charger, a converter, a motor controller (which may be referred to as an inverter system controller or ISC), etc., arranged and configured to establish the bidirectional transfer of electrical energy between the respective traction battery packs 20 of the leading and trailing vehicles 12, 14. The bidirectional power transfer systems 34 may additionally be configured to transfer energy between the traction battery packs 20 and the electric machines of each respective vehicle.

One non-limiting example of a suitable bidirectional power transfer system that may be employed for use within the leading vehicle 12 and/or the trailing vehicle 14 for achieving bidirectional power transfer is disclosed within US Patent Publication No. 2020/0324665, assigned to Ford Global Technologies, LLC, the disclosure of which is incorporated by reference herein. However, other bidirectional power transfer systems could also be utilized for achieving the bidirectional transfer of power between the leading and trailing vehicles 12, 14 within the scope of this disclosure.

FIG. 1 schematically illustrates a first in-flight configuration C1 of the system 10. During the first in-flight configuration C1, power may be transferred from the traction battery pack 20 of the leading vehicle 12 to the traction battery pack 20 of the trailing vehicle 14 (as schematically depicted by arrow 35).

FIG. 2 schematically illustrates a second in-flight configuration C2 of the system 10. During the second in-flight configuration C2, power may be transferred from the traction battery pack 20 of the trailing vehicle 14 to the traction battery pack 20 of the leading vehicle 12 (as schematically illustrated by arrow 37). In this way, the trailing vehicle 14 may charge the leading vehicle 12 during the in-flight towing and charging event, such as for increasing the towing distance that the leading vehicle 12 is capable of towing the trailing vehicle 14.

The teachings of this disclosure may be applicable for any type of vehicle as the leading vehicle 12 and for any type of vehicle as the trailing vehicle 14. For example, the leading vehicle 12 or the trailing vehicle 14 could be configured as a car, a truck, a van, a sport utility vehicle (SUV), etc.

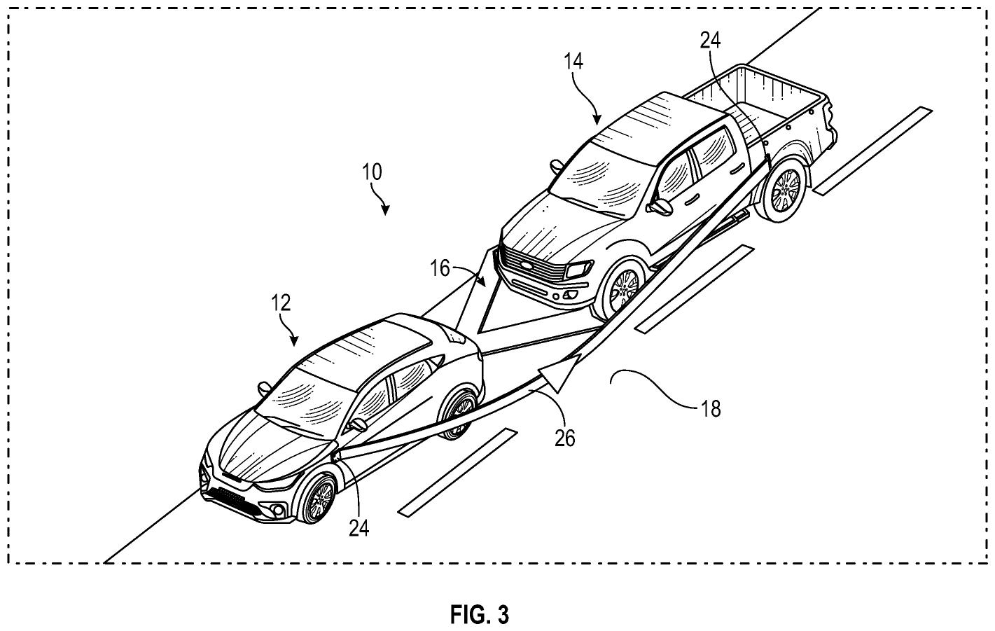

The leading vehicle 12 of FIGS. 1-2 is schematically illustrated as a pickup truck, and the trailing vehicle 14 of FIGS. 1-2 is schematically illustrated as a car. Thus, the trailing vehicle 14 is the smaller of the two vehicles in the embodiment of FIGS. 1-2. However, the leading vehicle 12 could alternatively be configured as the smaller of the two vehicles, and the trailing vehicle 14 could be configured as the larger of the two vehicles (see, e.g., the embodiment of FIG. 3).

Each of the leading and trailing vehicles 12, 14 may additionally be equipped with a steering system 70 for controlling the steering of each respective vehicle. In an embodiment, each steering system 70 is part of an electric power assisted system (EPAS). In another embodiment, the steering system 70 is part of a steer-by-wire system. However, other types of steering systems are also contemplated within the scope of this disclosure.

Each steering system 70 may include, among other things, a steering wheel 72, a steering shaft 74, and a steering rack 76 that is operably connected to the drive wheels 15. In an embodiment, the steering wheel 72 may be mechanically coupled to the steering shaft 74. In another embodiment, the steering wheel 72 and the steering shaft 74 are not mechanically linked, such as for steer-by-wire configurations.

A pinion gear 78 of the steering shaft 74 may operably engage the steering rack 76 in order to move the steering rack 76 in response to rotating the steering wheel 72. Motion of the steering wheel 72 may thus be transferred to the drive wheels 15 for steering the respective vehicle 12, 14.

The steering system 70 may additionally include one or more electric motors 80 that are operably connected to either the steering shaft 74 or the steering rack 76. The electric motor(s) 80 may be selectively controlled to apply power to the steering system 70, such as to control steering of the vehicle or to assist the driver in turning the steering wheel 72 in a desired direction. For example, an output shaft of the electric motor 80 may turn in the same direction as the steering wheel 72 in order to assist the turning motion of the steering wheel 72 as part of an EPAS.

In any of the scenarios depicted in FIGS. 1-3, the leading vehicle 12 could potentially require steering assistance from the trailing vehicle 14 for better maneuvering the coupled movement of the vehicles 12, 14 during select portions of the towing event. Steering assistance from the trailing vehicle 14 may be achieved by providing assistive steering maneuvers (e.g., by controlling the steering system 70 of the trailing vehicle 14) to help maneuver the leading vehicle 12 during select portions of the towing event. For example, the assistive steering maneuvers may be required to guide the coupled movement of the vehicles 12, 14 for accounting for turning maneuvers, steering compensation, stability events, etc. during the towing event. This disclosure therefore describes exemplary embodiments for coordinating and providing steering assistance from the trailing vehicle 14 to the leading vehicle 12 during towing events.

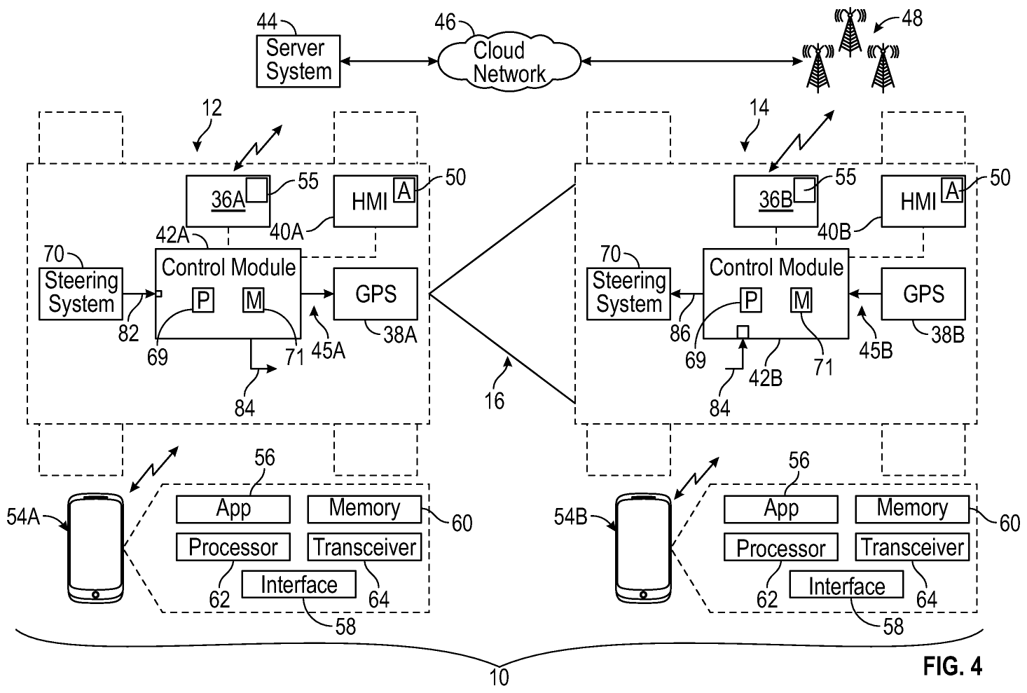

Additional functionality of the system 10 of FIGS. 1-3 is further detailed in FIG. 4. In particular, FIG. 4 schematically illustrates features that enable the system 10 to provide steering assistance from the trailing vehicle 14 to the leading vehicle 12 for achieving adequate maneuvering controls during select portions of a towing event between the respective vehicles. The steering assistance may be provided during the towing event whether or not energy is concurrently being supplied from the leading vehicle 12 to the trailing vehicle 14 or from the trailing vehicle 14 to the leading vehicle 12.

In an embodiment, the system 10 includes components from both the leading vehicle 12 and the trailing vehicle 14. For example, the leading vehicle 12 may include a telecommunications module 36A, a global positioning system (GPS) 38A, a human machine interface (HMI) 40A, and a control module 42A. These components may be interconnected and in electronic communication with one another over a communication bus 45A. The communication bus 45A may be a wired communication bus such as a controller area network (CAN) bus, or a wireless communication bus such as Wi-Fi, Bluetooth®, Ultra-Wide Band (UWB), etc.

As further part of the system 10, the trailing vehicle 14 may include a telecommunications module 36B, a global positioning system (GPS) 38B, a human machine interface (HMI) 40B, and a control module 42B. These components may be interconnected and in electronic communication with one another over a communication bus 45B. The communication bus 45B may be a wired communication bus such as a controller area network (CAN) bus, or a wireless communication bus such as Wi-Fi, Bluetooth®, Ultra-Wide Band (UWB), etc.

The telecommunications modules 36A, 36B may be configured for achieving bidirectional communications between the leading vehicle 12 and the trailing vehicle 14 over a cloud-based server system 44, such as for scheduling and executing in-flight vehicle-to-vehicle bidirectional energy transfers, for example. Each telecommunications module 36A, 36B may communicate over a cloud network 46 (i.e., the internal to obtain various information stored on the server system 44 or to provide information to the server system 44 that can subsequently be accessed by the leading vehicle 12 and/or the trailing vehicle 14 (or other participating vehicles). The server system 44 can identify, collect, and store user data associated with both the leading vehicle 12 and the trailing vehicle 14 for validation purposes. Upon an authorized request, data may be subsequently transmitted to the telecommunications modules 36A, 36B via one or more cellular towers 48 or via some other known communication technique (e.g., Wi-Fi, Bluetooth®, data connectivity, etc.). The information can then be communicated to the control module 42A, 42B for further processing. Each telecommunications module 36A, 36B can receive data from the server system 44 or communicate data back to the server system 44 via the cellular tower(s) 48. Although not necessarily shown or described in this highly schematic embodiment, numerous other components may enable bidirectional communications between the vehicles 12, 14 via the server system 44.

In an embodiment, a user/owner of the leading vehicle 12 and/or the trailing vehicle 14 may interface with the server system 44 using the HMI 40A, 40B. For example, each HMI 40A, 40B may be equipped with an application 50 (e.g., FordPass™ or another similar application) for interfacing with the server system 44. Each HMI 40A, 40B may be located within a passenger cabin of its respective vehicle and may include various user interfaces for displaying information to the vehicle occupants and for allowing the vehicle occupants to enter information into the HMI 40A, 40B. The vehicle occupants may interact with the user interfaces via touch screens, tactile buttons, audible speech, speech synthesis, etc.

In another embodiment, the user/owner of the leading vehicle 12 and/or the trailing vehicle 14 could alternatively or additionally interface with the server system 44 using a personal electronic device 54A, 54B (e.g., a smart phone, tablet, computer, wearable smart device, etc.). Each personal electronic device 54A, 54B may include an application 56 (e.g., FordPass™ or another similar application) that includes programming to allow the user to employ one or more user interfaces 58 for setting or controlling certain aspects of the system 10. The application 56 may be stored in memory 60 of the personal electronic device 54A, 54B and may be executed by a processor 62 of the personal electronic device 54A, 54B. Each personal electronic device 54A, 54B may additionally include a transceiver 64 that is configured to communicate with the server system 44 over the cellular tower(s) 48 or some other wireless link.

Each telecommunications module 36A, 36B may additionally include one or more wireless devices 55 that facilitate the detection of and communication with nearby vehicles, such as the leading vehicle 12 or the trailing vehicle 14, for example. Various information and signals, including steering-related information and signals, may be exchanged between the leading vehicle 12 and the trailing vehicle 14 via the wireless devices 55. In an embodiment, the wireless devices 55 are Bluetooth® Low Energy (BLE) transceivers configured to receive and/or emit low energy signals as a way to detect and communicate with participating vehicles. However, other types of wireless devices (e.g., WiFi, V2V, etc.) are also contemplated within the scope of this disclosure for enabling bidirectional communication between the leading vehicle 12 and the trailing vehicle 14.

Each GPS 38A, 38B is configured to pinpoint an exact location of the leading vehicle 12 or trailing vehicle 14, such as by using satellite navigation techniques. In an embodiment, the location data from the GPS 38A and/or the GPS 38B may be utilized to aid in determining a grade of the roadway 18 that the vehicles are traveling along during the towing event. The grade information can be helpful for determining the correct steering maneuvers to perform.

The control modules 42A, 42B may each include both hardware and software and could be part of an overall vehicle control system, such as a vehicle system controller (VSC), or could alternatively be a stand-alone controller separate from the VSC. In an embodiment, each control module 42A, 42B is programmed with executable instructions for interfacing with and commanding operation of various components of the system 10. Although shown as separate modules within the highly schematic depiction of FIG. 4, the telecommunications module, the GPS, the HMI, and the control module could be integrated together as part of common module within each of the leading vehicle 12 and the trailing vehicle 14.

Each control module 42A, 42B may include a processor 69 and non-transitory memory 71 for executing various control strategies and modes associated with the system 10. The processors 69 can be custom made or commercially available processors, central processing units (CPUs), or generally any device for executing software instructions. The memory 71 can include any one or combination of volatile memory elements and/or nonvolatile memory elements. The processor 69 may be operably coupled to the memory 71 and may be configured to execute one or more programs stored in the memory 71 of each control module 42A, 42B based on the various inputs received from other devices.

In an embodiment, based at least on a first input signal 82 received from the steering system 70 of the leading vehicle 12, the control module 42A may communicate (e.g., via the telecommunications modules 36A, 36B) a steering assistance request signal 84 to the control module 42B of the trailing vehicle 14. The first input signal 82 indicates that the steering wheel 72 of the leading vehicle 12 is being turned (e.g., rotated) and may include steering-related data associated with the leading vehicle 12. The steering-related data may include, but is not limited to, yaw rate (e.g., rate of rotation of turn), lateral acceleration (e.g., centrifugal force when turning), wheel speed (e.g., momentum control), steering wheel angle, vehicle weight, tire/wheelbase size, tire pressure, turn radius, parking brake status (e.g., engaged/not engaged), distance from front to rear wheels, distance from rear tire to vehicle hitch, etc.

The steering assistance request signal 84 indicates to the trailing vehicle 14 that the leading vehicle 12 requires steering assistance for achieving a desired level of maneuvering control when turning during the towing event. For example, the steering assistance could be needed to achieve certain turning maneuvers, to compensate for over/under steer conditions, to achieve improved stability during turns, to reduce tire scrub during turns, etc.

Target steering data that may be derived from the steering-related data associated with the leading vehicle 12 may be included as part of the steering assistance request signal 84. In response to receiving the steering assistance request signal 84, the control module 42B of the trailing vehicle 14 may calculate the required steering compensation necessary for achieving the steering target of the coupled vehicles. The control module 42B of the trailing vehicle 14 may then communicate a steering command signal 86 to the steering system 70 of the trailing vehicle 14 for commanding the steering system 70 to execute the necessary steering output of the trailing vehicle 14 for achieving desirable steering requirement thresholds of the coupled vehicles. In this way, the trailing vehicle 14 may be operated in coordination with the leading vehicle 12 in order to provide a towing steering system that steers the coupled vehicles as a single unit during towing events.

The information included as part of the steering command signal 86 may vary depending on the specifics of the target steering data for achieving various steering use cases of the system 10. In an embodiment, the actual steering rate of the trailing vehicle 14 depends on factors such as the vehicle speed or wheel speed, steering angle, yaw rate, and lateral acceleration of the leading vehicle 12. For lower speeds, the trailing vehicle 14 may be steered to compensate and allow for a wider turn radius, for example. To maintain stability around curves while traveling at high speeds, the steering of trailing vehicle 14 may be controlled to compensate for over/understeer conditions detected in leading vehicle 12, for example.

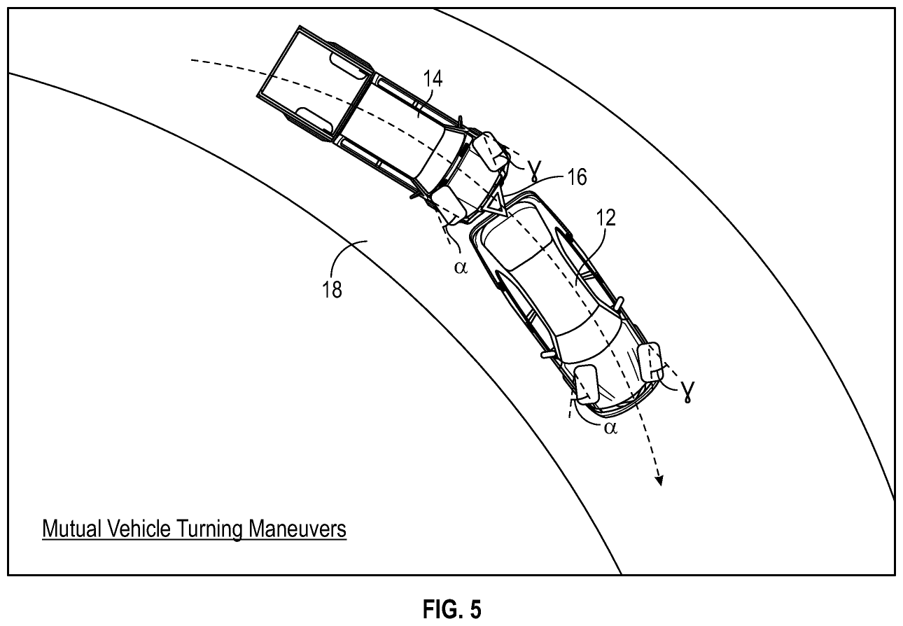

In an embodiment, the steering command signal 86 may command that the steering system 70 of the trailing vehicle 14 mimic the turn rate of the leading vehicle 12 in order to reduce tire scrubbing on the trailing vehicle 14 during mutual vehicle turning maneuvers. This particular use case is schematically illustrated in FIG. 5 and could be applied to both forward and reverse scenarios.

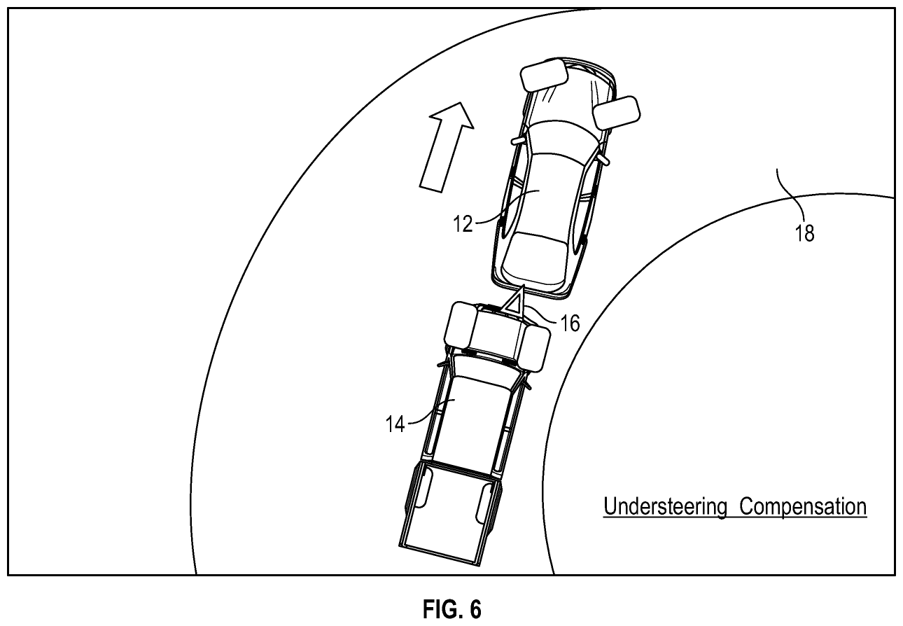

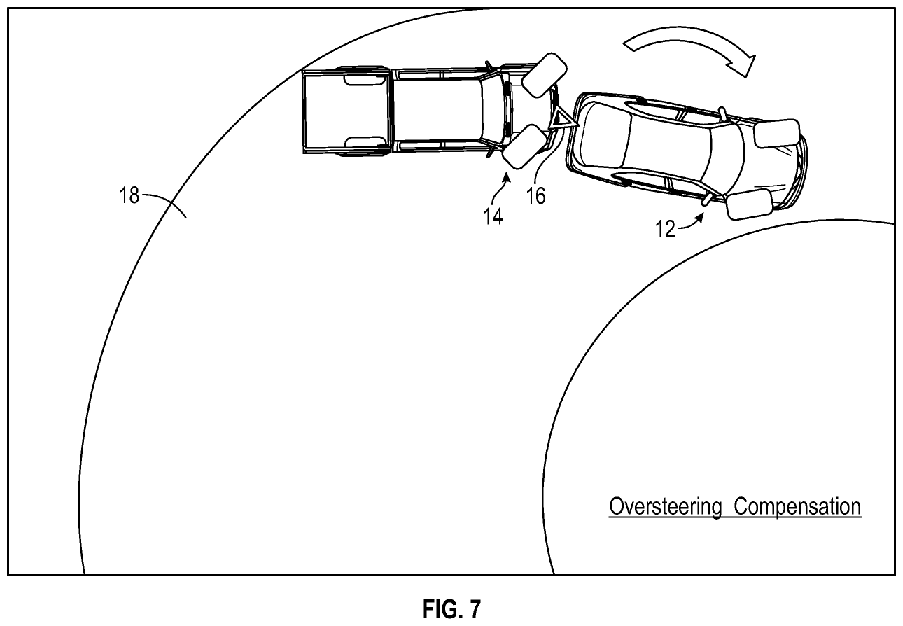

In another embodiment, the steering command signal 86 may command that the steering system 70 optimize the steering rate of the trailing vehicle 14 in order to compensate for oversteer or understeer conditions of the leading vehicle 12. For example, the steering command signal 86 may command the steering system 70 of the trailing vehicle 14 to reduce the steering rate of the trailing vehicle 14 during understeering conditions of the leading vehicle 12 (schematically shown in FIG. 6) or increase the steering rate of the trailing vehicle 14 during oversteering conditions of the leading vehicle 12 (schematically shown in FIG. 7). Thus, as illustrated by these embodiments, the turn rate of the trailing vehicle 14 may be controlled to be different from the turn rate of the leading vehicle 12.

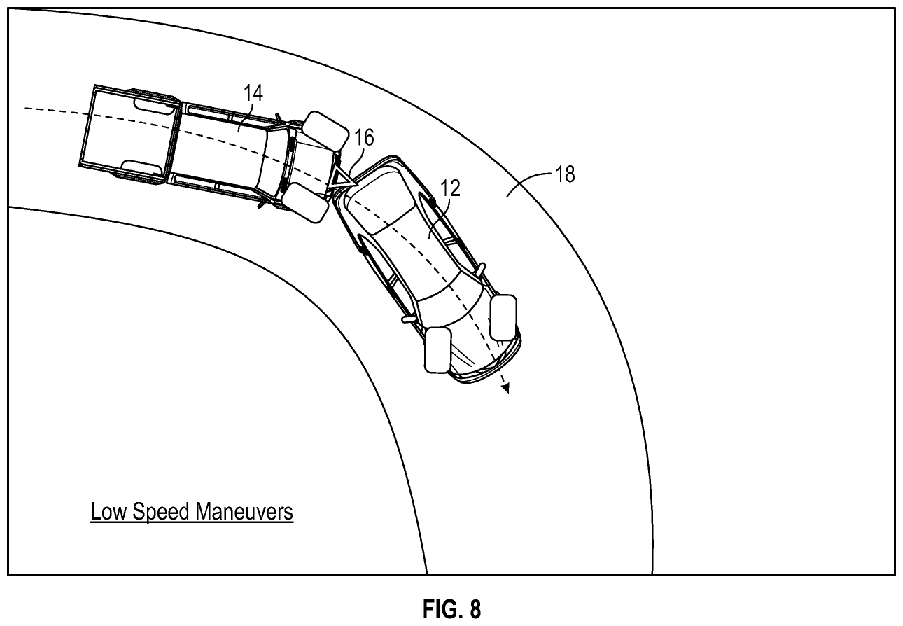

In yet another embodiment, the steering command signal 86 may command that the steering system 70 optimize the steering rate of the trailing vehicle 14 when the coupled vehicles are traveling below a predefined speed threshold (e.g., below about 5 miles per hour) and the steering wheel 72 of the leading vehicle 12 is positioned in a maximum rotation position (e.g., an end-to-end locked position). For example, the steering command signal 86 may command the steering system 70 of the trailing vehicle 14 to output the steering rate necessary for artificially creating oversteer in the leading vehicle 12 in order to assist the turning of the coupled vehicles around a tight turning radius during the towing event. This exemplary use case is schematically illustrated in FIG. 8. Other use cases are further contemplated within the scope of this disclosure for achieving desired turning targets of the coupled vehicles as part of a towed turning system.

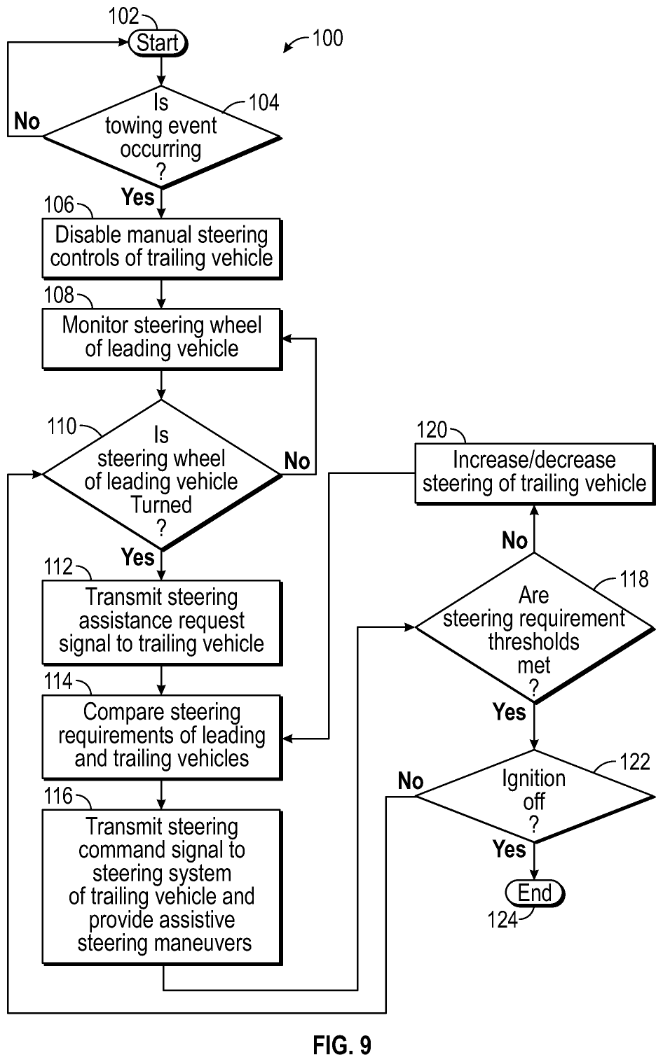

FIG. 9, with continued reference to FIGS. 1-8, schematically illustrates in flow chart form an exemplary method 100 for coordinating and providing steering assistance between the trailing vehicle 14 and the leading vehicle 12 during towing events in which the leading vehicle 12 is towing the trailing vehicle 14. The system 10 may be configured to employ one or more algorithms adapted to execute the steps of the exemplary method 100. For example, the method 100 may be stored as executable instructions in the memory 71 of each control module 42A, 42B, and the executable instructions may be embodied within any computer readable medium that can be executed by the processor 69 of each of the control modules 42A, 42B.

The exemplary method 100 may begin at block 102. At block 104, the method 100 may determine whether the leading vehicle 12 and the trailing vehicle 14 are engaged in a towing event. In an embodiment, the towing event is an in-flight bidirectional charging towing event in which the leading vehicle 12 and the trailing vehicle are connected by the towing device 16 and are further operably connected for achieving the bi-directional transfer of energy. It is noted, however, that energy does not need to be transferred continuously between the vehicles 12, 14 in order for the method 100 to be executed. Stated another way, there may be situations in which the leading vehicle 12 requires steering assistance during the towing event but energy is not currently being transferred between the respective vehicles for charging purposes.

If a YES flag is returned at block 104, the method 100 may optionally proceed to block 106 by disabling the manual steering controls of the trailing vehicle 14. Disabling the manual steering controls of the trailing vehicle 14 prevents a user of the trailing vehicle 14 from steering the vehicle 14 during the towing event. The manual steering controls of the trailing vehicle 14 may be re-enabled once the trailing vehicle 14 is decoupled from the leading vehicle 12 upon completion of the towing event. Alternatively, entry to the trailing vehicle 14 may optionally be prevented at block 106.

Next, at block 108, the method 100 may monitor a position of the steering wheel 72 of the leading vehicle 12. The method 100 may determine whether the steering wheel 72 is turned at block 110. The method 100 may assume a turning event is occurring when the steering wheel 72 of the leading vehicle 12 is turned (e.g., rotated clockwise or counterclockwise).

If the steering wheel 72 of the leading vehicle 12 is turned, the leading vehicle 12 may communicate the steering assistance request signal 84 to the trailing vehicle 14 at block 112. In response to receiving the steering assistance request signal 84, the trailing vehicle 14 may compare the steering requirements of the leading vehicle 12 with the steering requirements of the trailing vehicle 14 at block 114. This comparison may be performed by the control module 42B of the trailing vehicle 14 and may include calculating the required steering compensation (e.g., in the form of assistive steering maneuvers) necessary for achieving the steering target of the coupled vehicles.

At block 116, the steering command signal 86 may be transmitted to the steering system 70 of the trailing vehicle 14 for providing the assistive steering maneuvers during the towing event. The method 100 next determines whether the steering requirement thresholds of the coupled vehicles are met at block 118. If NO, the method 100 may proceed to block 120 by either increasing or decreasing the steering of the trailing vehicle 14. If YES, the method 100 may determine whether the ignition of the leading vehicle 12 is turned off at block 122. The method 100 may end at bock 124 if the ignition is turned off.

The vehicle-to-vehicle (V2V) in-flight energy transfer systems of this disclosure are designed to provide bidirectional charging while the participating vehicles are making forward progress toward their respective destinations. The systems are further configured to provide steering assistance to the leading/towing vehicle during the towing event. The steering assistance can help maneuver the coupled vehicles during towing events, thereby improving stability, increasing maneuverability, decreasing tire scrub/wear, etc.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle-to-vehicle in-flight energy transfer system, comprising:
a towing vehicle;
a towed vehicle; and
a control module programmed to request an assistive steering maneuver from the towed vehicle during a towing event between the towing vehicle and the towed vehicle.

2. The system as recited in claim 1, wherein the towing vehicle is a smaller vehicle than the towed vehicle.

3. The system as recited in claim 1, wherein the towed vehicle is coupled to the towing vehicle by a towing device during the towing event in which the assistive steering maneuver is requested.

4. The system as recited in claim 3, wherein the towing event is an in-flight bidirectional charging towing event.

5. The system as recited in claim 1, wherein the control module is a component of the towing vehicle.

6. The system as recited in claim 1, wherein the control module is programmed to transmit a steering assistance request signal to the towed vehicle when a steering wheel of the towing vehicle is turned.

7. The system as recited in claim 6, wherein the steering assistance request signal includes steering-related data associated with the towing vehicle.

8. The system as recited in claim 7, wherein the steering related data includes at least a yaw rate, a lateral acceleration, a wheel speed, and a steering wheel angle of the towing vehicle.

9. The system as recited in claim 6, wherein the control module is programmed to automatically communicate the steering assistance request signal in response to receiving an input signal from a steering system of the towing vehicle, and further wherein the input signal indicates that the steering wheel of the towing vehicle has been turned.

10. The system as recited in claim 1, wherein the control module is programmed to command that manual steering controls of the towed vehicle be disabled during the towing event.

11. The system as recited in claim 1, wherein the assistive steering maneuver is configured to mimic a turn rate of the towing vehicle.

12. The system as recited in claim 1, wherein the assistive steering maneuver is configured to compensate for an understeering or an oversteering condition of the towing vehicle.

13. The system as recited in claim 1, wherein the assistive steering maneuver is configured to artificially create an oversteer condition of the towing vehicle.

14. An electrified vehicle, comprising:
a drive wheel;
a steering system for electronically steering the drive wheel; and
a control module programmed to control the steering system for steering the drive wheel in response to receiving a steering assistance request signal during a towing event.

15. The electrified vehicle as recited in claim 14, wherein the steering assistance request signal is received from a second electrified vehicle.

16. The electrified vehicle as recited in claim 15, comprising a telecommunications module configured for establishing bidirectional communications between the electrified vehicle and the second electrified vehicle.

17. The electrified vehicle as recited in claim 14, wherein the control module is a component of the electrified vehicle being towed during the towing event.

18. The electrified vehicle as recited in claim 14, wherein the steering assistance request signal includes steering-related information received from a second electrified vehicle that is coupled to the electrified vehicle during the towing event.

19. The electrified vehicle as recited in claim 14, wherein the control module is programmed to:
calculate a required steering compensation necessary for achieving a steering target indicated by the steering assistance request signal; and
communicate a steering command signal to the steering system for commanding the steering system to execute the required steering compensation.

20. A method, comprising:
during a towing event in which a towing vehicle is towing a towed vehicle, controlling the towed vehicle to provide an assistive steering maneuver for providing a coupled maneuvering of the towed vehicle and the towing vehicle.
